(19) United States
(12) Patent Application Publication
(10) Pub. No.: US 2014/0148541 A1
(43) Pub. Date: May 29, 2014

(54) COMPOSITION

(71) Applicant: Alpin-Chemie GmbH, Sonthofen (DE)

(72) Inventor: Ralf-Peter WINKLER, Sonthofen (DE)

(73) Assignee: Alpin-Chemie GmbH, Sonthofen (DE)

(21) Appl. No.: 14/091,497

(22) Filed: Nov. 27, 2013

(30) Foreign Application Priority Data
Nov. 28, 2012 (DE) 10 2012 111 549.4

(51) Int. Cl. C09D 129/14; C08K 5/05

(52) U.S. Cl. CPC C09D 129/14; C08K 5/05
USPC 524/379

(57) ABSTRACT

A composition for use as a release agent and wash-out coating for concrete products, wherein on the one hand active ingredients for the release agent and also on the other hand active ingredients for washing out of the concrete surface are present in the composition and together form a layer.

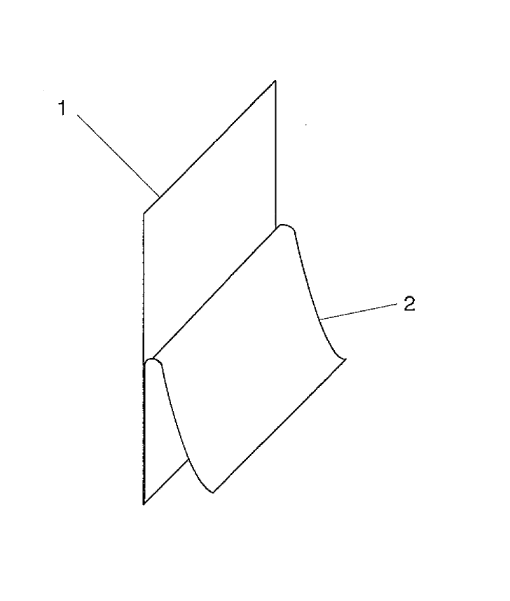

### CROSS REFERENCE TO RELATED APPLICATIONS

Applicant claims priority under 35 U.S.C. §119 of German Application No. 10 2012 111 549.4 filed Nov. 28, 2012, the disclosure of which is incorporated by reference.

### BACKGROUND OF THE INVENTION

1. Field of the Invention

The invention relates to a composition for use as a release agent and wash-out coating for concrete products.

2. Description of the Related Art

Wash-out coatings of most diverse kinds for concrete products are known, but these can be processed only with difficulty.

On the other hand, chemical release agents of most diverse kinds for concrete products are also known.

The compositions either do not form layers or have to be expensively washed away or due to an acidic formulation have a tendency, particularly in the case of formation of a film, to generate rust on the formwork.

It is in fact well-known to combine these two characteristics with one another, but these combinations are usable only with difficulty.

The resulting contaminations of the washing water are not insignificant and cannot be disregarded.

### SUMMARY OF THE INVENTION

The object of the invention is therefore to propose a composition which on the one hand has excellent characteristics with respect to release from formwork as well as washing out and on the other hand has a simple and environmentally conserving capability of processing.

According to the invention this object is fulfilled in that on the one hand active ingredients for the release agent and on the other hand active ingredients for washing out the concrete surface are present in the composition and together form a layer.

Due to the layer formation, on the one hand the efficacy of the washing out is promoted and on the other hand a good capability of release from formwork is ensured. In addition, the layer can be withdrawn as a whole and disposed of. It can be disposed of by way of, for example, domestic waste at the latest after drying of the layer. Contamination of the washing water does not occur.

In that regard it has proved to be very advantageous if an anti-adhesion agent, particularly a salt of an amino acid, is present.

Salts of an amino acid have proved to be very good anti-adhesion agents and thus separating agents for concrete products.

According to the invention it is extremely advantageous if a polyvinylbutyral, polyvinylalcohol or the like is provided as a layer forming agent.

A stable layer is thereby formed.

In that case it has also proved to be very advantageous if a co-binder is provided, which, for example, can derive from the group of alkyd resins.

Through the use of co-binders compatible with polyvinylbutyral the layer formation is further improved. Stable layers are produced.

Similarly, according to a further embodiment of the invention it is very advantageous if an anti-foaming agent, preferably a modified polysiloxane or other anti-foaming agent, is provided.

Foam would lead to irregularities in the coating, which in turn would have the consequence of a non-uniform surface of the concrete product.

A further, very advantageous embodiment of the invention is present if a setting retardant, particularly a sugar or modified sugars, salts of carboxylic acids such as, for example, gluconates, citrates or the like, is provided.

There are numerous setting retardants. However, very good characteristics were achieved with sugar and modified sugar. In addition, sugar is not environmentally harmful. However, very good results were also achieved with salts of carboxylic acids and these, similarly, are not harmful to the environment.

According to a further development of the invention it is extremely advantageous if a solvent, particularly an alcohol, water or another solvent, is provided.

Solvents ensure a liquid composition of the coating substance and thus make possible an easy capability of processing.

In that case it has proved very advantageous if a rapid-volatilization solvent is provided.

It is thus ensured that the coating is quickly ready for use. The preparation time until the concrete can be introduced into the formwork is thus minimized.

It is also very advantageous if a colorant is provided.

It can thus be very easily visually checked whether the applied amount of the composition is sufficient.

A further very advantageous embodiment of the invention is also present if a filler is provided.

A greater layer thickness of the composition is achieved by the use of a filler.

A similarly very advantageous development of the invention is present if an anti-settling agent, particularly a sheet silicate, is provided in the composition. Segregation of the composition, particularly during use, is thereby prevented.

An extremely advantageous composition is present if the composition contains the following ingredients:

| | |
|---|---|
| PVB/PVOH | 1-50 weight %, preferably 1-30 weight % |
| separating agent | 1-10 weight %, preferably approximately 2 |
| | weight % |
| anti-foaming agent | 0-5 weight %, preferably 0.1-5 weight % |
| setting retardant | 1-50 weight % |
| filler | 30 weight %, preferably 1-20 weight %. |

The best results were achieved with these components. The wash-out depth of the concrete was influenced by variation of the proportion of the setting retardant.

An extremely advantageous coating according to the invention from a composition according to the invention is present if the coating is applied to a formwork serving as formwork for a concrete part to be produced.

An easy capability of processing is thus ensured.

### BRIEF DESCRIPTION OF THE DRAWINGS

The invention is explained in the following by way of an embodiment.

In that case the single FIGURE shows an illustration of a formwork with a partly pulled-off coating according to the invention.

### DETAILED DESCRIPTION OF PREFERRED EMBODIMENTS

A composition of 10% PVB of medium chain length, 2% separating agent, 0.1% anti-foaming agent, 11% setting retardant, colorant and 2% anti-settling agent and filler. Isopropylalcohol is provided as solvent, wherein also ethanol or the like is usable.

The binder used in that case has non-alkaline solubility, so that the composition cannot be etched away and destroyed by concrete water escaping during setting.

Used as filler in this example are microscale hollow spheres, which assist layer built-up. However, sheet silicates, other silicates or non-silicatic fillers, which are not soluble in the solvent, are also conceivable here.

This composition is applied to the formwork, in which the concrete product is to be made, on all contact surfaces with respect to the concrete. The required minimum layer thickness is readily apparent due to the included colorant. As soon as the applied layer exhibits uniform coloration, a sufficient layer has been applied. A layer thickness exceeding that is not necessary, but does not negatively influence the achieved result.

The composition forms a solid film on the formwork.

If the concrete is now introduced into the thus-treated formwork then the setting retardant present in the composition, which in the present example is sugar, acts on the concrete. After setting of the concrete the formwork is removed. As a rule, the film from the composition remains adhering to the formwork and can be removed there without problems like a film sheet. Even if the composition film should remain adhering to the concrete product it can be easily mechanically removed there.

Instead of sugar, use can also be made of salts of carboxylic acids such as, for example, gluconates, citrates or the like as setting retardants. Combinations are possible.

Any remaining residues can be removed during washing away either by a high-pressure cleaning agent or, however, by a brush, broom or the like.

The film is not water-soluble, but is disposed of as a solid, wherein this solid is quite safe with respect to its environmental compatibility.

After removal of the film through releasing from formwork the concrete product can be washed out. The wash-out depth in the case of the aforesaid composition is approximately four millimeters.

Depending on the respective chain length of the PVB used and the desired viscosity the proportion of PVB can be varied. Equally, higher or lower proportions of the setting retardant are conceivable.

In addition, co-binders compatible with the principal binder can be provided. For example, alkyd resins have proved suitable for the invention and can ensure a further improved layer formation.

Other solvents can equally well be used. Due to the neutral formulation of the composition, rust on the formwork elements is largely prevented. Tendency to rust formation is similarly reduced through dispensing with water as solvent.

After removal of the film from the formwork material this is equally freed of concrete residues and does not have to be subject to additional, expensive cleaning. Rather, the formwork material is immediately ready for re-use. Possible residues can be easily removed. In addition, no dust arises, since brushing away of residues is redundant.

Due to omission of the need for cleaning, water consumption is also significantly reduced, since it is largely possible to dispense with washing water.

In a composition according to this embodiment the active ingredient of the setting retardant is not soluble in the solvent. Rather, this is distributed in the composition. Accordingly, it is useful to integrate an anti-settling agent in order to achieve a uniform dispersion of the composition at least during use of the composition.

The composition can be brushed, rolled or also sprayed onto the formwork. The form of application is not relevant with respect to effectiveness. The sole critical aspect is that the requisite minimum layer thickness is achieved.

Through use of a solvent with rapid volatilization it is possible to adhere to short preparation times. It is not necessary to wait for setting of the composition or for layer formation. The concrete can be introduced a short time after applying the composition to the formwork.

Use can be made of, for example, a modified polysiloxane as anti-foaming agent.

If water is used as solvent, then formation of rust has to be taken into account in the case of formwork elements of steel.

The composition according to the invention can, due to its layer formation which leads to a removable film, be disposed of simply and without problems in appropriate manner.

During removal from formwork the film usually adheres to the formwork and can then be pulled off this. Possible concrete residues adhere to the film. Concrete components which are higher up can also be produced in this mode and manner without the separating agent having to be removed from the concrete with use of, for example, ladders.

Even in the case of larger and large elements the film can still be pulled off the formwork without problems. Tests have already shown that films from two to one meter can be pulled off in one piece without problems.

If the film were to adhere to the concrete then this would during washing out of the concrete be broken down into fine particles. This would in turn lead to a disposal problem, since drains or the like would very easily be blocked, as is the case with known compositions.

Since the composition does not contain any dangerous and environmentally harmful substances the film can be easily disposed of after use.

It is possible to dispense with solvents containing hydrocarbons, such as, for example, special grades of petroleum spirit or white petroleum spirit, whereby risk to health is significantly reduced.

In addition, there is no presence of acids which on the one hand would lead to formation of corrosion on metallic formwork elements and on the other hand would produce irritation of breathing passages. The usual pungent odor in the case of processing of release agents with acid content is completely eliminated.

The alcohols used as solvent and also the absence of acids mean that special protective precautions are not necessary, such as, for example, breathing protection or the like.

A formwork plate is denoted by 1 in the FIGURE. Disposed on this is a film 2 of the composition according to the invention. The state after release from the formwork is illustrated in the drawing. The film 2, together with possible residues of the concrete, is already partly pulled off the formwork plate 1.

What is claimed is:

1. A composition for use as a release agent and wash-out coating for concrete products, wherein on the one hand active ingredients for the release agent and on the other hand active ingredients for washing out the concrete surface are present in the composition and together form a layer.

2. The composition according to claim 1, wherein an anti-adhesion agent is present.

3. The composition according to claim 1, wherein the anti-adhesion agent is a salt of an amino acid.

4. The composition according to claim 1, wherein a polyvinylbutyral, polyvinylalcohol or the like is provided as layer former.

5. The composition according to claim 4, wherein a co-binder is provided.

6. The composition according to claim 3, wherein the co-binder derives from the group of alkyd resins.

7. The composition according to claim 1, wherein an anti-foaming agent is provided.

8. The composition according to claim 7, wherein the anti-foaming agent is a modified polysiloxane.

9. The composition according to claim 1, wherein a setting retardant is provided.

10. The composition according to claim 9, wherein the setting retardant comprises a sugar or modified sugars, salts of carboxylic acids.

11. The composition according to claim 9, wherein the setting retardant comprises gluconates, citrates or the like.

12. The composition according to claim 1, wherein a solvent is provided.

13. The composition according to claim 12, wherein the solvent is an alcohol or water.

14. The composition according to claim 12, wherein a fast-volatilization solvent is provided.

15. The composition according to claim 1, wherein a colorant is provided.

16. The composition according to claim 1, wherein a filler is provided.

17. The composition according to claim 1, wherein an anti-settling agent is provided in the composition.

18. The composition according to claim 17, wherein the anti-settling agent is a sheet silicate.

19. The composition according to claim 1, wherein the composition contains the following ingredients:

| | |
|---|---|
| PVB/PVOH | 1-50 weight %, preferably 1-30 weight % |
| separating agent | 1-10 weight %, preferably approximately 2 |
| | weight % |
| anti-foaming agent | 0-5 weight %, preferably 0.1-5 weight % |
| setting retardant | 1-50 weight % |
| filler | 30 weight %, preferably 1-20 weight %. |

20. A coating comprising a composition according to claim 1, wherein the coating is applied to formwork serving as formwork for a concrete component to be produced.
